(19) United States
(12) Patent Application Publication
(10) Pub. No.: US 2015/0264854 A1
(43) Pub. Date: Sep. 24, 2015

(54) Gardening Tool Assembly

(71) Applicant: Tina J. Meadows, Indianapolis, IN (US)

(72) Inventor: Tina J. Meadows, Indianapolis, IN (US)

(21) Appl. No.: 14/219,252

(22) Filed: Mar. 19, 2014

(51) Int. Cl. A01B 1/08

(52) U.S. Cl. CPC A01B 1/08

(57) ABSTRACT

A gardening tool assembly allows a person to dig holes into the dirt using a single hand. The assembly includes an elongated shaft having a first end and a second end. A handle is coupled to the first end of the shaft. A blade is coupled to the second end of the shaft and is configured for being inserted into an area of soil. A stop is coupled to the shaft. A perimeter edge of the stop extends outwardly beyond an outer diameter of the shaft wherein the stop is configured to prevent a user's hand from sliding down the shaft beyond the stop when the user's hand is grasping the handle.

### BACKGROUND OF THE DISCLOSURE

### Field of the Disclosure

The disclosure relates to gardening tool devices and more particularly pertains to a new gardening tool device for allowing a person to dig holes into the dirt using a single hand.

### SUMMARY OF THE DISCLOSURE

An embodiment of the disclosure meets the needs presented above by generally comprising an elongated shaft having a first end and a second end. A handle is coupled to the first end of the shaft. A blade is coupled to the second end of the shaft and is configured for being inserted into an area of soil. A stop is coupled to the shaft. A perimeter edge of the stop extends outwardly beyond an outer diameter of the shaft wherein the stop is configured to prevent a user's hand from sliding down the shaft beyond the stop when the user's hand is grasping the handle.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top front side perspective view of a gardening tool assembly according to an embodiment of the disclosure.

FIG. 2 is a top front side perspective view of an alternative embodiment of the disclosure.

FIG. 3 is a front view of an embodiment of the disclosure.

FIG. 4 is a side view of an embodiment of the disclosure.

### DESCRIPTION OF THE PREFERRED EMBODIMENT

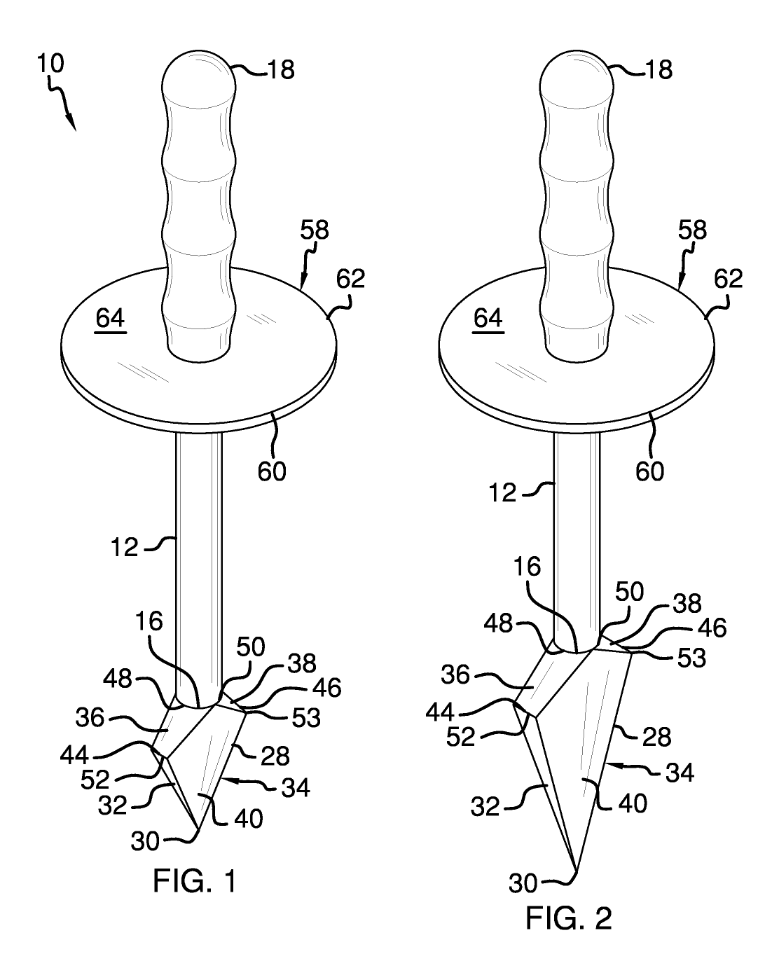

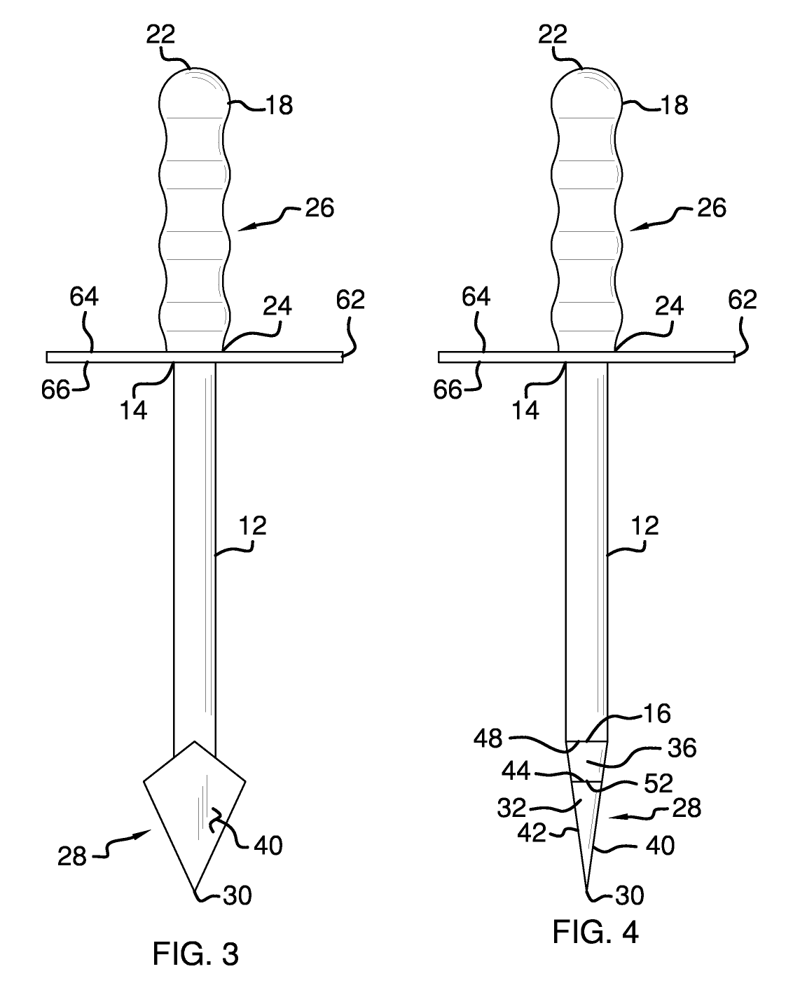

With reference now to the drawings, and in particular to FIGS. 1 through 4 thereof, a new gardening tool device embodying the principles and concepts of an embodiment of the disclosure and generally designated by the reference numeral 10 will be described.

As best illustrated in FIGS. 1 through 4, the gardening tool assembly 10 generally comprises an elongated shaft 12 having a first end 14 and a second end 16. A longitudinal axis extends through the shaft 12 between the first end 14 and the second end 16. A handle 18 is coupled to the first end 14 of the shaft 12. The handle 18 includes a plurality of finger grips 26 that extend circumferentially around the handle 12 between a top end 22 and a bottom end 24 of the handle 18. The handle 18 is constructed from a strong and durable material, such as plastic, metal or the like. The handle 18 and the shaft 12 may be integrally coupled or may be formed from separate pieces of material.

A blade 28 is coupled to the second end 16 of the shaft 12. The blade 28 is configured for being inserted into an area of soil for digging a hole in the area of soil. The blade 28 may be collinear with respect to the longitudinal axis of the shaft 12. The blade 28 includes a distal end 30 with respect to the handle 18. The distal end 30 may be pointed. The blade 28 comprises a plurality of planar faces 32, 34, 36, 38, 40, 42 and may comprise exactly six planar faces. The planar faces 32, 34, 36, 38, 40, 42 include a pair of lateral faces 32, 34, a pair of top faces 36, 38, and a front face 40 positioned opposite a rear face 42. Each of the top faces 36, 38 is attached to the second end 16 of the shaft 12 and slants downwardly and outwardly relative to the second end 16 of the shaft 12. Each of the top faces 36, 38 has a distal edge 44, 46 and a proximal edge 48, 50 with respect to the second end 16 of the shaft 12. Each top face 36, 38 may taper inwardly from the proximal edge 48, 50 to the associated distal edge 44, 46. Each of the lateral faces 32, 34 extends upwardly and outwardly from the distal end 30 of the blade 28 in opposite directions with respect to each other. Each of the lateral faces 32, 34 has an associated top edge 52, 53. Each lateral face 32, 34 may taper inwardly from the top edge 52, 53 to the distal end 30 of the blade 28. Each of the top faces 36, 38 is attached to the top edge 52, 53 of an associated one of the lateral faces 32, 34. Each of the front 40 and rear 42 faces may be diamond-shaped. Each of the blade 28 and the shaft 12 are constructed from a rigid material, such as metal. As shown in the Figures, the blade 28 may be constructed in various sizes. In particular, FIG. 2 shows an embodiment of the disclosure having an enlarged blade 28. The assembly 10 may have a length between approximately 20.0 cm and 25.0 cm extending from the top end 22 of the handle 18 to the distal end 30 of the blade 28.

A stop 58 is coupled to the shaft 12. A perimeter edge 60 of the stop 58 extends outwardly beyond an outer diameter of the shaft 12 wherein the stop 58 is configured to prevent a user's hand from sliding down the shaft 12 beyond the stop 58 when the user's hand is positioned on and is grasping the handle 18. The perimeter edge 60 of the stop 58 may be annular. The stop 58 may comprise a plate 62 having an upper surface 64 and a lower surface 66 each being planar. The perimeter edge 60 of the stop 58 is coupled to and positioned between the upper surface 64 and the lower surface 66. The stop 58 may be positioned in vertically spaced relationship above the blade 28 and may also be positioned between the handle 18 and the first end 14 of the shaft 12. The stop 58 is also constructed from a durable material, such as metal, plastic or the like. In the event that the handle 18 and the shaft 12 are integrally coupled, the stop 58 may have a central hole through which the handle 18 and shaft 12 extend. Alternatively, in the event that the handle 18 and the shaft 12 are formed from separate pieces of material, the stop 58 may be completely solid between the upper 64 and lower 66 surfaces.

In use, as stated above and shown in the Figures, the user grasps the handle 18 with a single hand and inserts the blade 28 into an area of soil. The user moves the assembly 10 in a circular motion in order to separate the soil without disrupting any mulch that was applied to the soil. This allows the user to dig a hole in the soil in order to plant a flower or other plant in the soil. The user is able to control how great of a circular motion to apply in order to create a larger or smaller hole as desired.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A gardening tool assembly comprising:
an elongated shaft having a first end and a second end;
a handle coupled to said first end of said shaft;
a blade coupled to said second end of said shaft, said blade being configured for being inserted into an area of soil for digging a hole in the area of soil; and
a stop coupled to said shaft, a perimeter edge of said stop extending outwardly beyond an outer diameter of said shaft wherein said stop is configured to prevent a user's hand from sliding down said shaft beyond said stop when the user's hand is grasping said handle.

2. The assembly of claim 1, further comprising wherein said stop comprises a plate having an upper surface and a lower surface, said perimeter edge of said stop being coupled to and positioned between said upper surface and said lower surface, each of said upper and lower surfaces being planar.

3. The assembly of claim 1, further comprising wherein said perimeter edge of said stop is annular.

4. The assembly of claim 1, further comprising wherein said stop is positioned in vertically spaced relationship above said blade.

5. The assembly of claim 1, further comprising wherein said stop is positioned between said handle and said first end of said shaft.

6. The assembly of claim 1, further comprising wherein a longitudinal axis extends through said shaft between said first end and said second end, said blade being collinear with respect to said longitudinal axis of said shaft.

7. The assembly of claim 1, further comprising said handle including a plurality of finger grips extending circumferentially around said handle between a top end and a bottom end of said handle.

8. The assembly of claim 1, further comprising wherein said blade comprises a plurality of planar faces.

9. The assembly of claim 8, further comprising wherein said blade comprises exactly six of said planar faces.

10. The assembly of claim 1, further comprising wherein said blade includes a distal end with respect to said handle, said distal end being pointed.

11. The assembly of claim 9, wherein said planar faces include a front face opposite a rear face, each of said front and rear faces being diamond-shaped.

12. The assembly of claim 8, further comprising:
wherein said blade includes a distal end with respect to said handle; and
said planar faces including a pair of lateral faces, each of said lateral faces extending upwardly and outwardly from said distal end of said blade in opposite directions with respect to each other.

13. The assembly of claim 12, further comprising wherein said planar faces further include a pair of top faces, each of said top faces being attached to and slanting downwardly and outwardly relative to said second end of said shaft, each of said lateral faces having an associated top edge, each of said top faces being attached to said top edge of an associated one of said lateral faces.

14. The assembly of claim 13, further comprising wherein each of said top faces has a distal edge and a proximal edge with respect to said second end of said shaft, each said top face tapering inwardly from said proximal edge to said associated distal edge.

15. The assembly of claim 12, further comprising each of said lateral faces having an associated top edge, each said lateral face tapering inwardly from said associated top edge to said distal end of said blade.

16. A gardening tool assembly comprising:
an elongated shaft having a first end and a second end, a longitudinal axis extending through said shaft between said first end and said second end;
a handle coupled to said first end of said shaft, said handle including a plurality of finger grips extending circumferentially around said handle between a top end and a bottom end of said handle;
a blade coupled to said second end of said shaft, said blade being configured for being inserted into an area of soil for digging a hole in the area of soil, said blade being collinear with respect to said longitudinal axis of said shaft, said blade including a distal end with respect to said handle, said distal end being pointed, said blade comprising a plurality of planar faces, said blade comprising exactly six of said planar faces, said planar faces including a pair of lateral faces, a pair of top faces, and a front face opposite a rear face, each of said top faces being attached to and slanting downwardly and outwardly relative to said second end of said shaft, each of said top faces having a distal edge and a proximal edge with respect to said second end of said shaft, each said top face tapering inwardly from said proximal edge to said associated distal edge, each of said lateral faces extending upwardly and outwardly from said distal end of said blade in opposite directions with respect to each other, each of said lateral faces having an associated top edge, each said lateral face tapering inwardly from said associated top edge to said distal end of said blade, each of said top faces being attached to said top edge of an associated one of said lateral faces, each of said front and rear faces being diamond-shaped; and
a stop coupled to said shaft, a perimeter edge of said stop extending outwardly beyond an outer diameter of said shaft wherein said stop is configured to prevent a user's hand from sliding down said shaft beyond said stop when the user's hand is grasping said handle, said perimeter edge of said stop being annular, said stop comprising a plate having an upper surface and a lower surface, said perimeter edge of said stop being coupled to and positioned between said upper surface and said lower surface, each of said upper and lower surfaces being planar, said stop being positioned in vertically spaced relationship above said blade, said stop being positioned between said handle and said first end of said shaft.
